(19) United States
(12) Patent Application Publication
(10) Pub. No.: US 2019/0129068 A1
(43) Pub. Date: May 2, 2019

(54) RIGID GAS PERMEABLE OPHTHALMIC LENS MATERIAL AND RIGID GAS PERMEABLE OPHTHALMIC LENS OF SUCH MATERIAL

(71) Applicant: HON HAI PRECISION INDUSTRY CO., LTD., New Taipei (TW)

(72) Inventor: Hsiu-wen Chien, New Taipei (TW)

(21) Appl. No.: 15/820,365

(22) Filed: Nov. 21, 2017

(30) Foreign Application Priority Data
Oct. 31, 2017 (TW) 106137669

(51) Int. Cl. G02B 1/04; C08G 77/20

(52) U.S. Cl. CPC G02B 1/043; C08G 77/20

(57) ABSTRACT

A rigid gas permeable ophthalmic lens material comprises a silicone resin, a fluorochemical, an acrylate monomer, and a thermal initiator. The lens made therefrom thus has a high oxygen permeability. A rigid gas permeable ophthalmic lens made of the rigid gas permeable ophthalmic lens material is also provided.

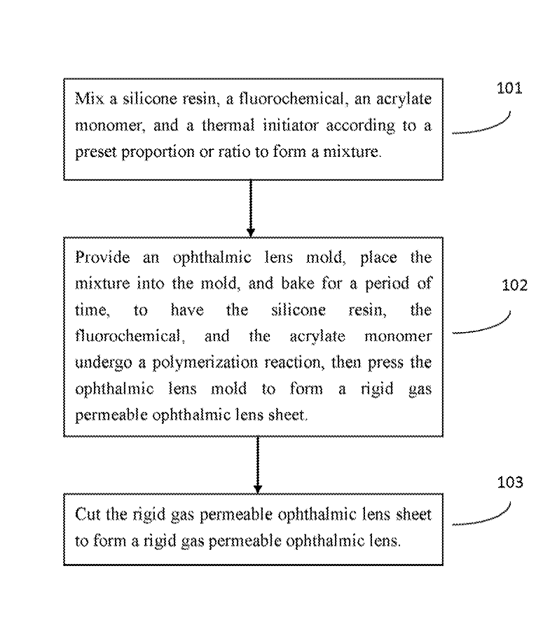

### FIELD

The subject matter generally relates to eye-health technology, and particularly to a rigid gas permeable ophthalmic lens material and a rigid gas permeable ophthalmic lens.

### BACKGROUND

Ophthalmic lenses are worn by users to correct vision, or for cosmetic or therapeutic reasons. Since the ophthalmic lens directly contacts eyes of the user when in use, ophthalmic lens that allow gas such as oxygen to pass through is needed.

### BRIEF DESCRIPTION OF THE DRAWING

Implementations of the present disclosure will now be described, by way of example only, with reference to the attached FIGURE, the FIGURE being a flowchart of an exemplary embodiment of a method for manufacturing a rigid gas permeable ophthalmic lens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “comprising” when utilized, means “including, but not necessarily limited to”; it specifically indicates open-ended inclusion or membership in the so-described combination, group, series, and the like. The term “about” when utilized, means “not only includes the numerical value, but also includes numbers closest to the numerical value”.

An exemplary embodiment of a rigid gas permeable ophthalmic lens material comprises a silicone resin, a fluorochemical, an acrylate monomer, and a thermal initiator.

In at least one exemplary embodiment, the silicone resin has a mass percentage of about 5.35% to about 62.96% of the total mass of the rigid gas permeable ophthalmic lens material, the fluorochemical has a mass percentage of about 4.35% to about 28.95% of the total mass of the rigid gas permeable ophthalmic lens material, and the acrylate monomer has a mass percentage of about 32.08% to about 90.03% of the total mass of the rigid gas permeable ophthalmic lens material. A mass percentage of the thermal initiator in the rigid gas permeable ophthalmic lens material is not limited.

The silicone resin may be selected from tetraethoxysilane (TEOS), methyl-trimethoxysilane (MTMS), 3-(trimethoxysilyl)propyl methacrylate (MPTMS), or any combination thereof.

The fluorochemical may be selected from perfluorohexylethyl acrylate (PFHEA), octafluoropentyl acrylate (OFPA), dodecafluoroheptyl acrylate (DFHA), or any combination thereof.

The acrylate monomer may be selected from methyl methacrylate (MMA), methacrylic acid (MAA), 2-Hydroxyethyl methacrylate (HEMA), or any combination thereof.

The thermal initiator may be selected from azobisisobutyronitrile (AIBN), 4,4′-Azobis(4-cyanovaleric acid) (ACVA), 2,2′-Azobis(2-imidazoline) dihydrochloride (AIP), or any combination thereof.

An exemplary embodiment of a rigid gas permeable ophthalmic lens formed by the rigid gas permeable ophthalmic lens material is provided.

The FIGURE illustrates a flowchart of a method for making the rigid gas permeable ophthalmic lens with an exemplary embodiment. The exemplary method is provided by way of example, as there are a variety of ways to carry out the method. Each block shown in the FIGURE represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method may begin at block 101.

At block 101, a silicone resin, a fluorochemical, an acrylate monomer, and a thermal initiator are mixed according to a preset proportion or ratio to form a mixture.

At block 102, an ophthalmic lens mold is provided, the mixture is placed into the mold, and is baked for a period of time, to have the silicone resin, the fluorochemical, and the acrylate monomer undergo a polymerization reaction, then the ophthalmic lens mold is pressed to form a rigid gas permeable ophthalmic lens sheet.

In at least one exemplary embodiment, the mixture is baked at a temperature of about 65 degrees Celsius to about 95 degrees Celsius, the mixture is baked for a period of time of about 0.5 hour to about 12 hours.

At block 103, the rigid gas permeable ophthalmic lens sheet is cut to form a rigid gas permeable ophthalmic lens.

When being heated, in the rigid gas permeable ophthalmic lens material, the thermal initiator causes polymerization of the silicone resin, the fluorochemical, and the acrylate monomer to form a high molecular polymer. The high molecular polymer contains a plurality of long chains. The rigid gas permeable ophthalmic lens material comprises silicone resin and fluorochemical, thus the rigid gas permeable ophthalmic lens material comprises silicon atoms and fluorine atoms. The silicon atom and the fluorine atom can have the high molecular polymer have a big space between the chains, thus a penetrating power of oxygen molecules in the high molecular polymer is strong, thereby the rigid gas permeable ophthalmic lens formed by the rigid gas permeable ophthalmic lens material has a high oxygen permeability.

### EXAMPLE 1

The rigid gas permeable ophthalmic lens material comprises PFHEA, MPTMS, MMA, AIBN, and TEOS.

The PFHEA has a mass percentage of 6.67% of the total mass of the rigid gas permeable ophthalmic lens material, the MPTMS has a mass percentage of 13.33% of the total mass of the rigid gas permeable ophthalmic lens material, the MMA has a mass percentage of 46.67% of the total mass of the rigid gas permeable ophthalmic lens material, the AIBN has a mass percentage of 0.82% of the total mass of the rigid gas permeable ophthalmic lens material, and the TEOS has a mass percentage of 32.51% of the total mass of the rigid gas permeable ophthalmic lens material.

The rigid gas permeable ophthalmic lens was made by putting the rigid gas permeable ophthalmic lens material in an ophthalmic lens mold, then baking at a temperature of 87 degrees Celsius for 5 hours, then pressing the ophthalmic lens mold to form a rigid gas permeable ophthalmic lens sheet, then cutting the rigid gas permeable ophthalmic lens sheet.

The rigid permeable ophthalmic lens has a light transmittance of about 97%.

The rigid gas permeable ophthalmic lens has an oxygen permeability coefficient of 160.

### EXAMPLE 2

The rigid gas permeable ophthalmic lens material comprises PFHEA, MPTMS, HEMA, AIBN, and TEOS.

The PFHEA has a mass percentage of 13.32% of the total mass of the rigid gas permeable ophthalmic lens material, the MPTMS has a mass percentage of 13.33% of the total mass of the rigid gas permeable ophthalmic lens material, the HEMA has a mass percentage of 45.28% of the total mass of the rigid gas permeable ophthalmic lens material, the AIBN has a mass percentage of 0.85% of the total mass of the rigid gas permeable ophthalmic lens material, and the TEOS has a mass percentage of 27.22% of the total mass of the rigid gas permeable ophthalmic lens material.

The rigid gas permeable ophthalmic lens was made by putting the rigid gas permeable ophthalmic lens material in an ophthalmic lens mold, then baking at a temperature of 90 degrees Celsius for 8 hours, then pressing the ophthalmic lens mold to form a rigid gas permeable ophthalmic lens sheet, then cutting the rigid gas permeable ophthalmic lens sheet.

The rigid permeable ophthalmic lens has a light transmittance of about 97%.

The rigid gas permeable ophthalmic lens has an oxygen permeability coefficient of 160.

### EXAMPLE 3

The rigid gas permeable ophthalmic lens material comprises PFHEA, MPTMS, HEMA, MTMS, AIBN, and TEOS.

The PFHEA has a mass percentage of 12.32% of the total mass of the rigid gas permeable ophthalmic lens material, the MPTMS has a mass percentage of 12.33% of the total mass of the rigid gas permeable ophthalmic lens material, the HEMA has a mass percentage of 43.85% of the total mass of the rigid gas permeable ophthalmic lens material, the MTMS has a mass percentage of 8.45% of the total mass of the rigid gas permeable ophthalmic lens material, the AIBN has a mass percentage of 0.85% of the total mass of the rigid gas permeable ophthalmic lens material, and the TEOS has a mass percentage of 22.2% of the total mass of the rigid gas permeable ophthalmic lens material.

The rigid gas permeable ophthalmic lens was made by putting the rigid gas permeable ophthalmic lens material in an ophthalmic lens mold, then baking at a temperature of 90 degrees Celsius for 8 hours, then pressing the ophthalmic lens mold to form a rigid gas permeable ophthalmic lens sheet, then cutting the rigid gas permeable ophthalmic lens sheet.

The rigid permeable ophthalmic lens has a light transmittance of about 98%.

The rigid gas permeable ophthalmic lens has an oxygen permeability coefficient of 150.

### EXAMPLE 4

The rigid gas permeable ophthalmic lens material comprises OFPA, MPTMS, MMA, MTMS, AIBN, and TEOS.

The OFPA has a mass percentage of 13.42% of the total mass of the rigid gas permeable ophthalmic lens material, the MPTMS has a mass percentage of 13.51% of the total mass of the rigid gas permeable ophthalmic lens material, the MMA has a mass percentage of 40.69% of the total mass of the rigid gas permeable ophthalmic lens material, the MTMS has a mass percentage of 8.89% of the total mass of the rigid gas permeable ophthalmic lens material, the AIBN has a mass percentage of 0.9% of the total mass of the rigid gas permeable ophthalmic lens material, and the TEOS has a mass percentage of 22.59% of the total mass of the rigid gas permeable ophthalmic lens material.

The rigid gas permeable ophthalmic lens was made by putting the rigid gas permeable ophthalmic lens material in an ophthalmic lens mold, then baking at a temperature of 90 degrees Celsius for 8 hours, then pressing the ophthalmic lens mold to form a rigid gas permeable ophthalmic lens sheet, then cutting the rigid gas permeable ophthalmic lens sheet.

The rigid permeable ophthalmic lens has a light transmittance of about 98%.

The rigid gas permeable ophthalmic lens has an oxygen permeability coefficient of 180.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A rigid gas permeable ophthalmic lens material comprising:
a silicone resin;
a fluorochemical; and
an acrylate monomer.

2. The rigid gas permeable ophthalmic lens material of claim 1, wherein the silicone resin has a mass percentage of about 5.35% to about 62.96% of the total mass of the rigid gas permeable ophthalmic lens material, the fluorochemical has a mass percentage of about 4.35% to about 28.95% of the total mass of the rigid gas permeable ophthalmic lens material, and the acrylate monomer has a mass percentage of about 32.08% to about 90.03% of the total mass of the rigid gas permeable ophthalmic lens material.

3. The rigid gas permeable ophthalmic lens material of claim 1, wherein the silicone resin is selected from tetraethoxysilane, methyl-trimethoxysilane, 3-(trimethoxysilyl)propyl methacrylate, and any combination thereof.

4. The rigid gas permeable ophthalmic lens material of claim 1, wherein the fluorochemical is selected from perfluorohexylethyl acrylate, octafluoropentyl acrylate, dodecafluoroheptyl acrylate, and any combination thereof.

5. The rigid gas permeable ophthalmic lens material of claim 1, wherein the acrylate monomer is selected from methyl methacrylate, methacrylic acid, 2-Hydroxyethyl methacrylate, and any combination thereof.

6. The rigid gas permeable ophthalmic lens material of claim 1, wherein the rigid gas permeable ophthalmic lens material further comprises a thermal initiator.

7. The rigid gas permeable ophthalmic lens material of claim 6, wherein the thermal initiator is selected from azobisisobutyronitrile, 4,4′-Azobis(4-cyanovaleric acid), 2,2′-Azobis(2-imidazoline) dihydrochloride, and any combination thereof.

8. A rigid gas permeable ophthalmic lens formed with:
a rigid gas permeable ophthalmic lens material, the rigid gas permeable ophthalmic lens material comprising:
a silicone resin;
a fluorochemical; and
an acrylate monomer.

9. The rigid gas permeable ophthalmic lens of claim 8, wherein the silicone resin has a mass percentage of about 5.35% to about 62.96% of the total mass of the rigid gas permeable ophthalmic lens material, the fluorochemical has a mass percentage of about 4.35% to about 28.95% of the total mass of the rigid gas permeable ophthalmic lens material, and the acrylate monomer has a mass percentage of about 32.08% to about 90.03% of the total mass of the rigid gas permeable ophthalmic lens material.

10. The rigid gas permeable ophthalmic lens of claim 8, wherein the silicone resin is selected from tetraethoxysilane, methyl-trimethoxysilane, 3-(trimethoxysilyl)propyl methacrylate, and any combination thereof.

11. The rigid gas permeable ophthalmic lens of claim 8, wherein the fluorochemical is selected from perfluorohexylethyl acrylate, octafluoropentyl acrylate, dodecafluoroheptyl acrylate, and any combination thereof.

12. The rigid gas permeable ophthalmic lens of claim 8, wherein the acrylate monomer is selected from methyl methacrylate, methacrylic acid, 2-Hydroxyethyl methacrylate, and any combination thereof.

13. The rigid gas permeable ophthalmic lens of claim 8, wherein the rigid gas permeable ophthalmic lens material further comprises a thermal initiator.

14. The rigid gas permeable ophthalmic lens of claim 13, wherein the thermal initiator is selected from azobisisobutyronitrile, 4,4′-Azobis(4-cyanovaleric acid), 2,2′-Azobis(2-imidazoline) dihydrochloride, and any combination thereof.
